(19) United States
(12) Patent Application Publication
(10) Pub. No.: US 2005/0087575 A1
(43) Pub. Date: Apr. 28, 2005

(54) Dual storage compartment hidden behind motorcycle license plate

(76) Inventors: Alex Samsel, Raleigh, NC (US); Jeffrey Draper, Morrisville, NC (US)

Correspondence Address: Donald W. Meeker, 924 East Ocean Front #E, Newport Beach, CA, 92661, US

(21) Appl. No.: 10/695,052

(22) Filed: Oct. 27, 2003

(51) Int. Cl. B62J 7/00; B62J 9/00; B62J 11/00

(52) U.S. Cl. 224/413

(57) ABSTRACT

A hidden dual storage compartment is bolted behind a motorcycle license plate. A document storage “wallet” and kickstand support can be stored in two separate sides of the compartment.

### BACKGROUND OF THE INVENTION

1. Field of the Invention

The present invention relates to motorcycle storage compartments and accessories and particularly to a dual storage compartment attached and hidden behind a motorcycle license plate, the compartment holding both a document “wallet” and a kickstand support.

2. Description of the Prior Art

Motorcyclists are faced with problems not common to other vehicles. The two-wheeled motorcycle without additional saddle bags has no storage space, so that documents such as vehicle registrations are often carried in the driver's wallet. Furthermore, because the motorcycle has only two wheels, it relies on a kickstand in addition to the wheels to support the motorcycle when parked.

When a motorcycle rests on a solid surface such as cement or asphalt, the kickstand or side support works quite well. A serious problem emerges, however, when the motorcycle stands on sand, dirt, grass, or other non-solid surface. In such case, the lower extreme of the kickstand tends to sink into the soft surface as driven by the weight of the motorcycle, which may topple over. In fact, larger motorcycles may be so heavy that they may be difficult or impossible to erect by a single person once they fall over. Many motorcycle systems only work when the bike is upright, such as the carburetor and fuel tank. If a motorcycle is allowed to lie on its side, the fuel may leak out of the gas tank. In addition, if the motorcycle uses a liquid-filled battery, the battery acid may leak out of the battery, to the corrosive detriment of anything it touches. Modern motorcycles are designed to rest on their wheels and kickstands—their turn signal lamps and other accessories may be broken or scratched if the motorcycle is allowed to rest on its side. Thus, preventing the kickstand from penetrating soft surfaces and consequently causing the motorcycle to fall on its side has become necessary.

Prior art devices have made some attempt at solving these unique motorcycle problems, but have not addressed both effectively.

Prior art U.S. Pat. No. 5,503,420, issued Apr. 2, 1996 to Consiglio, provides a parking accessory for motorcycles that has a frame which provides a first compartment for a license plate, and a second compartment behind the first compartment to carry a plate-like kickstand pad which can be removed and placed under the end of the kickstand when it is desired to park the motorcycle. The kickstand pad prevents penetration of the surface on which the motorcycle is resting and consequent loss of upright support of the cycle.

Prior art U.S. Pat. No. 5,979,339, issued Nov. 9, 1999 to Smith, indicates a lock box apparatus that is adapted for use with license plate mounting structures. The lock box assembly is mountable to a vehicle to receive an item to be protected and to affix a license plate thereto. The lock box apparatus comprises an elongated housing formed by an anchoring plate and a door and having an interior sized to receive the protected item. The anchoring plate has a pair of anchoring holes that are alignable with installation holes on the vehicle so that the anchoring plate may be mounted to the vehicle. The door is pivotally mounted to the anchoring plate between a closed position enclosing the interior and preventing access to the protected item and an opened position exposing the interior and permitting access to the protected item. The door is provided with a pair of door holes registerable with cooperative holes in the license plate so that the license plate may be affixed thereto. A latching assembly latches the door to the anchoring plate and has a secured state whereby the door is disposed in the closed position and an unsecured state whereby the door is movable between the closed and opened positions thereby to allow access to the protected item.

Prior art U.S. Pat. No. 4,182,062, issued Jan. 8, 1980 to Krokos, shows a license plate lock box assembly that is adapted to be secured about, preferably, the rear license plate of a motor vehicle. The assembly comprises a holding means adapted to be secured to the motor vehicle, a transparent cover plate adapted to cover and enclose the license plate, and a locking means adapted to releasably lock the cover plate to the holding means. The cover plate includes a horizontal slot through which notices of traffic violations may be inserted and retained in the assembly.

Prior art U.S. Pat. No. 5,947,038, issued Sep. 7, 1999 to Smith, describes a security box apparatus that is adapted for use with a conventional license plate mounting structure of a vehicle, which includes a plurality of spaced apart installation holes. The security box apparatus is adapted to affix a license plate thereto to secure a protected item and comprises a housing member, a door, a locking structure and a license plate mounting assembly. The housing member is provided with a plurality of anchoring holes alignable with the installation holes so that a mounting fastener may extend through these holes to securely fasten the housing member to the license plate mounting structure. A recess is formed in the housing member and the door is sized and adapted to be received in this recess to enclose the interior and the protected item. The door is movable between a closed position wherein access to the interior is prevented and an opened position wherein access to the protected item is permitted. The locking structure has a secured state to latch the door to the recess in the closed position and a non-secured state whereby the door is movable from the closed position to the opened position. The license plate mounting assembly is disposed on the housing member and is for attaching the license plate to the housing member in a mounted position wherein the license plate conceals the door from view.

Prior art U.S. Pat. No. 5,528,998, issued Jun. 25, 1996 to Smith, discloses a lock box apparatus that is adapted for mounting onto mounting structure to secure a protected item thereto. The lock box apparatus comprises an anchoring plate, a door, and a latching assembly. The door is connected to the anchoring plate to provide a housing that is fastened to the mounting structure. The housing has an interior sized to receive the item to be protected. The door is operative to move between a closed position and an open position. In the closed position, the interior is enclosed thereby preventing access to the protected item. In the open position, the interior is exposed thereby permitting access to the protected item. The latching assembly has a secured state and an unsecured state. In the secured state, the door is locked onto the housing in the closed position thereby preventing access to the protected item. In the unsecured state, the door is movable between the closed and open positions thereby allowing access to the protected item. An exemplary embodiment of the lock box apparatus is adapted for mounting onto a mounting structure for a license plate of a motor vehicle to secure a key and for affixing the license plate thereto. This exemplary embodiment can be mounted either over the license plate to expose it in view of the general public or behind the license plate to hide it from the view of the general public.

Prior art U.S. Patent Application #20030042261, published Mar. 6, 2003 by Cantor, puts forth a motorcycle gas tank that has a lockable compartment to hold items or articles such as vehicle registration, insurance, tools, sunglasses, gloves and the like. The compartment has an opening that may be enclosed by a cap that may be lockable. The compartment may be releasable from the gas tank so that a rider may take the items in the compartment with the rider for security. The cap may have a key opening that may move or align to a number of different positions such as open the compartment position, lock everything position, and open the gas tank position.

Prior art U.S. Patent Application #20020121534, published Sep. 5, 2002 by Hanagan, concerns a readily removable storage unit for mounting on the rear fender of a motorcycle, which comprises a storage compartment member defining an open cavity and a cover pivotably mounted on the compartment member adjacent its front end for movement between a cavity closing position and an open position. A lock is provided on the compartment member and the cover adjacent the rear wall for securing the cover in the cavity closing position. A fastener on the bottom wall of the compartment member is engageable with the rear fender of the motorcycle, and the saddle and compartment member have a cooperating releasable tongue and bracket so that the storage unit is mounted by first engaging the saddle and then engaging the fastener in the motorcycle rear fender.

Prior art U.S. Pat. No. 5,257,803, issued Nov. 2, 1993 to Fisher, concerns a support platform that is adapted to prevent kickstands and other load carrying members from sinking into an underlying surface. The support platform is generally disc shaped and is provided with a channel or cut-out therein which aids in establishing and/or maintaining an alignment between the kickstand and the support platform as the kickstand is being lowered onto the support platform. The support platform is particularly suited for mass production.

What is needed is a hidden storage compartment on a motorcycle for storing papers, such as a registration and proof if insurance papers, as well as a storage compartment for a kickstand support to be used when parking the motorcycle on unstable surfaces.

### SUMMARY OF THE INVENTION

An object of the present invention is to provide a hidden dual storage compartment behind a license plate on a motorcycle for storing papers, such as a registration and proof of insurance papers, as well as for storing a kickstand support to be used when parking the motorcycle on unstable surfaces.

Another object of the present invention is to provide a dual storage compartment for motorcycles which is inexpensive to manufacture and may be mass-produced of molded synthetic material.

One more object of the present invention is to provide a motorcycle document holder that is hidden behind the license plate to prevent theft of the documents, such as a title, registration or proof of insurance papers.

An additional object of the present invention is to provide a kickstand support pad that prevents a motorcycle kickstand from penetrating soft surfaces, thereby preventing the motorcycle from toppling over and sustaining damage.

In brief, a hidden storage compartment mounts behind a standard motorcycle license plate attached by the license plate screws or bolts. The storage casing comprising two planar casing surfaces positioned apart by a distance sufficiently wide to form a receiving space between them. Top and bottom interconnecting edges and a middle vertical wall create two separate storage chambers each with an elongated end opening.

Inserted in one chamber is a two-part paper storage “wallet” comprising two planar “wallet” faces pivotally interconnected along a mating edge, preferably a living hinge for a molded plastic “wallet”. The two planar “wallet” faces may fold over each other so that edge protrusions between the two planar “wallet” faces in a closed position form an enclosed water-tight container that stores documents folded up inside.

The “wallet” is inserted within the first elongated opening on one side of the casing. The “wallet may be snap fit in the casing by means of a protrusion from the “wallet” engaging a detente inside the casing. The “wallet” has a “wallet” outer edge that covers the first opening of the casing, the “wallet” outer edge has a grooved finger grasping means at a top and bottom of a protruding edge frame for grasping the “wallet” to insert it into and remove it from the casing. The edge frame seals the elongated opening in the closed position.

A kickstand support insertable in the other chamber comprises a flat planar support surface that supports a bottom end of a motorcycle kickstand resting on a soft surface. A pair of angled ridges protruding from the surface of the kickstand support pad prevent the kickstand from sliding horizontally over its flat planar support surface. The kickstand support is structured to fit within the second elongated opening on the other side of the casing. The kickstand support further comprises an easy-to-grasp expanded kickstand support outer edge that seals the second elongated opening of the casing with the kickstand support fully inserted.

All of the components are formed of molded plastic. There are a series of indents in the bottom casing planar surface, and a series of mating protrusions in the cover planar casing surface to secure the two planar casing surfaces, which may further be cemented or heat staked together.

The hidden storage compartment device is mounted behind a standard motorcycle license plate by means of the plate screws or bolts, which are inserted through a pair of mating spaced openings located in the two planar casing surfaces.

An advantage of the present invention is that it provides storage space for documents on a motorcycle.

Another advantage of the present invention is that it provides a kickstand support and storage space for the support.

An additional advantage of the present invention is that it prevents theft of the documents.

One more advantage of the present invention is that it is economical to manufacture.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a front perspective view of the motorcycle storage compartment of the present invention showing the front cover of the compartment which fits behind and contacts the back of the motorcycle license plate;

FIG. 2 is a front elevational view of the paper storage “wallet” of the storage compartment of FIG. 1 showing the “wallet” in the open position;

FIG. 3 is a rear elevational view of the kickstand support of the storage compartment of FIG. 1;

FIG. 3A is a front elevational view of the kickstand support of the storage compartment of FIG. 1 shown in the orientation for insertion in the storage compartment of FIG. 1;

FIG. 4 is a front elevational view of the rear portion of the motorcycle storage compartment of the present invention showing the spaces for receiving the “wallet” of FIG. 2 and the kickstand support of FIGS. 3 and 3A.

### BEST MODE FOR CARRYING OUT THE INVENTION

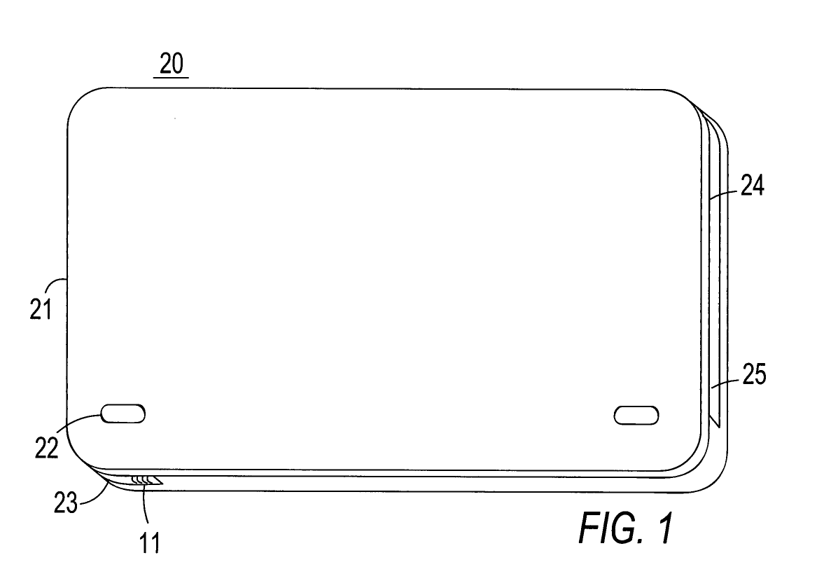

In FIGS. 1-4, a hidden storage compartment device 20 for mounting behind a standard motorcycle license plate (not shown) has a casing comprising two planar casing surfaces 21 and 25, both structured to fit behind the license plate. The planar casing surfaces 21 and 25 are positioned apart by a distance sufficiently wide to form a receiving space 26 and 27 between the two planar casing surfaces. A top and bottom interconnecting edge 8 between the two planar casing surfaces 21 and 25 seals the top and bottom of the casing and a vertical interconnecting wall 8A divides the casing into two chambers 26 and 27 with elongated side end openings 26A and 27A.

A pair of mating spaced openings 22 are formed through both of the planar casing surfaces 21 and 25, which are spaced apart a sufficient distance to align with and receive a pair of screws or bolts (not shown) for attaching a standard motorcycle license plate (not shown) to a motorcycle so that the casing 21 and 25 may be mounted behind the standard motorcycle license plate in a concealed position.

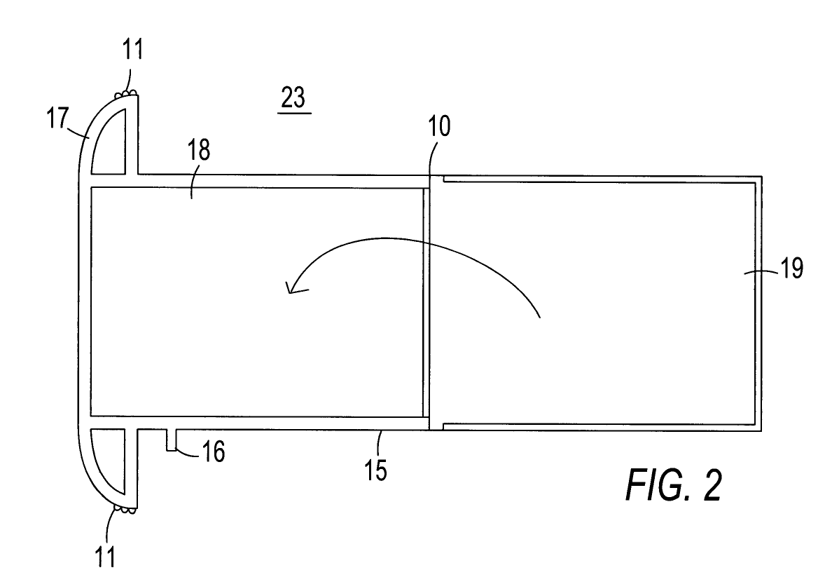

The hidden storage compartment device 20 also includes a two-part paper storage “wallet” 23 comprising two planar “wallet” faces 18 and 19 pivotally interconnected along a mating edge of the two planar “wallet” faces 18 and 19. The “wallet” 23 is preferably formed of molded plastic and the mating edge preferably comprises a living hinge 10, as shown in FIG. 2. The two planar “wallet” faces 18 and 19 preferably fold over each other. Edge protrusions 15 are provided between the two planar “wallet” faces 18 and 19 that when in a closed position form an enclosed water-tight container, which may store documents and papers folded up (not shown) inside the enclosed “wallet”.

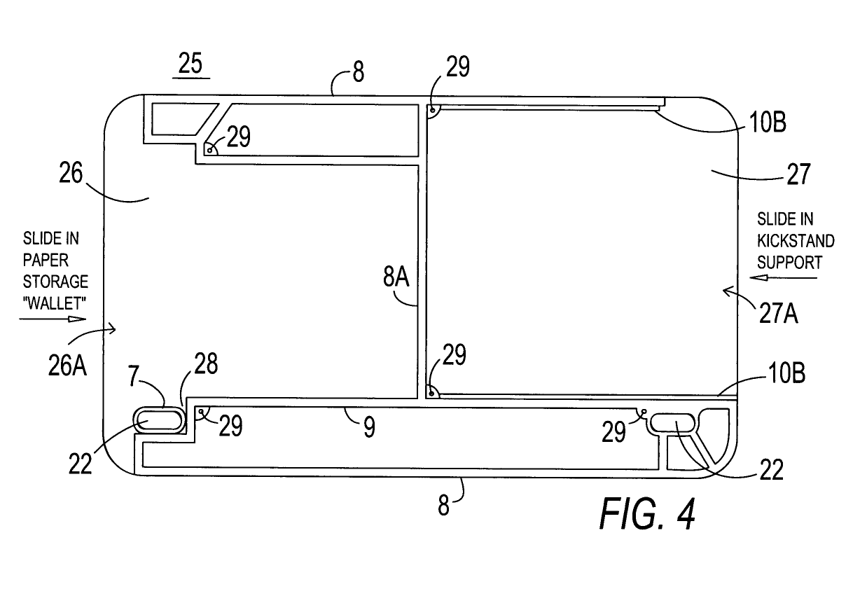

The “wallet” 23 is preferably inserted within the first chamber 26 through the first elongated opening 26A on one side of the casing. The “wallet” and the casing further comprise mating means for securing the “wallet” in the casing, preferably a protrusion 16, shown in FIG. 2, from one, in this case the “wallet” 23, which may snap fit into engagement into an aligned indent 28, shown in FIG. 4 in the other, in this case the casing. The casing may further comprise a rim 7, as shown in FIG. 4, around a spaced opening 22 located on the side of the first elongated opening 26. The indent 28 may be formed adjacent to an inside edge of the rim 7.

The “wallet” 23 further comprises a “wallet” outer edge 17, or end frame, capable of covering the first elongated end opening 26A of the casing in the fully inserted position. The “wallet” outer edge 17 has a means for grasping such as grooves 11 at a top and bottom of the outer edge 17 to insert the “wallet” into and remove the “wallet” from the casing.

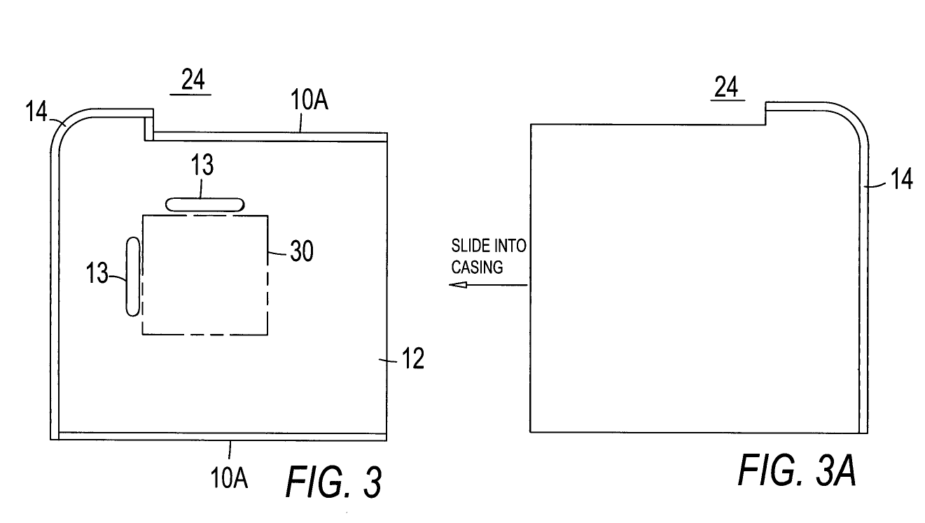

The hidden storage compartment device 20 further comprises a kickstand support 24, seen in FIGS. 3 and 3A, comprising a flat planar support surface 12, which preferably supports a bottom end of a motorcycle kickstand 30 (shown dashed in FIG. 3) for supporting the kickstand on a soft surface. The flat planar support surface 12 has a protruding means, preferably a pair of ridges 13 protruding from the flat planar surface 12 with one of the pair of ridges positioned at an angle relative to the other ridge, as shown in FIG. 3, to form a stop for the kickstand 30 to prevent the kickstand 30 from horizontal movement over the flat planar support surface 12 of the kickstand support 24. The kickstand support 24 is structured to fit within the second chamber 27 through the second elongated opening 27A on the other side of the casing from the “wallet”. The kickstand support 24 further comprises a kickstand support protruding outer edge 14, ir edge frame, which preferably covers the second elongated opening 27A with the kickstand support inserted in the casing, the outer edge 14 serving as a means for grasping the kickstand support 24 to insert the kickstand support into and remove the kickstand support from the casing.

All of the components of the device 20 are preferably formed of molded plastic. A series of indents 29, shown in FIG. 4, are located in one of the two planar casing surfaces, in this case the bottom casing planar surface 25. A series of mating protrusions (not shown), in the other of the two planar casing surfaces, in this case in the cover 21, mate with the indents 29 to secure the two planar casing surfaces 21 and 25 together.

A protruding track ridge 9 extends between the two planar casing surfaces 21 and 25 aligned with the tops of the mating spaced openings 22, as shown in FIG. 4. The protruding track ridge 9 defines a bottom edge of an interior of the casing to maintain any contents above the mating spaced openings 22. A portion of the protruding track ridge 9 adjacent to the second elongated opening 27A comprises a lower beveled insertion track 10B, as shown in FIG. 4. An interior portion of the top interconnecting edge 8 of the casing adjacent to the second elongated opening 27A comprises an upper beveled insertion track 10B. The kickstand support 24 further comprises a top beveled edge 10A, shown in FIG. 3, that mates with the upper beveled insertion track 10B of the casing 25 and a bottom beveled edge 10A mating with the lower beveled insertion track 10B of the casing 25 so that the kickstand support 24 slides into the second elongated opening 27 of the casing 25 on the beveled insertion tracks 10B, with a tight friction fit.

In practice the hidden storage compartment device 20 would be mounted in a concealed position attached behind a standard motorcycle license plate (not shown), by the license plate screws or bolts (not shown) inserted through the pair of mating spaced openings 22.

Documents, such as proof of insurance, vehicle registration or titles (not shown), may be stored in the two-part paper storage “wallet” 23, shown in FIG. 2. The paper may be folded and placed between the two planar “wallet” faces 18 and 19, which may be folded together in a closed position to form an enclosed water-tight container. The “wallet” 23 may be held at the grasping ridges 11 and inserted into or removed from the first elongated opening 26. The “wallet” 23 is preferably structured to snap fit into place inside the casing.

The kickstand support 24, shown in FIGS. 3 and 3A, may be removed from the second elongated opening 27 of the casing and placed under the motorcycle kickstand 30 to prevent the kickstand 30 from penetrating soft surfaces and consequently causing the motorcycle to fall on its side. The kickstand 30 is positioned in between the pair of ridges 13, shown in FIG. 3, which form a stop for the kickstand 30 to prevent the kickstand 30 from horizontal movement over the flat planar support surface 12 of the kickstand support 24.

After use, the kickstand support 24 may be inserted into the second elongated opening 27A, engaging the beveled edges 10A with the upper beveled insertion tracks 10B of the casing, thereby causing the kickstand support 24 to be held in place by a frictional fit.

It is understood that the preceding description is given merely by way of illustration and not in limitation of the invention and that various modifications may be made thereto without departing from the spirit of the invention as claimed.

1. A hidden storage compartment device for mounting behind a standard motorcycle license plate, the device comprising:
a casing comprising two planar casing surfaces each capable of fitting behind a standard motorcycle license plate, the planar casing surfaces positioned apart by a distance sufficiently wide to form a receiving space between the two planar casing surfaces and a top and bottom interconnecting edge between the two planar casing surfaces to form a storage compartment therebetween with a first elongated opening along one side edge and a second elongated opening along an opposing side edge of the casing, a pair of mating spaced openings formed through both of the planar casing surfaces, the openings spaced apart a sufficient distance to align with and receive a pair of screws for attaching a standard motorcycle license plate to a motorcycle so that the casing is capable of being mounted behind the standard motorcycle license plate in a concealed position behind the standard license plate;
a two-part paper storage “wallet” comprising two planar “wallet” faces pivotally interconnected along a mating edge of the two planar “wallet” faces, the two planar “wallet” faces capable of folding over each other, and edge protrusions between the two planar “wallet” faces in a closed position to form an enclosed water-tight container capable of storing at least one piece of paper folded up inside the enclosed container, the “wallet” being capable of insertion within the first elongated opening on one side of the casing, the “wallet” and the casing further comprising mating means for securing the “wallet” in the casing, the “wallet” further comprising a “wallet” outer edge capable of covering the first opening of the casing, the “wallet” outer edge having a means for grasping the kickstand support to insert the “wallet” into and remove the “wallet” from the casing;
a kickstand support comprising a flat planar support surface capable of supporting a bottom end of a motorcycle kickstand resting on a soft surface, the flat planar support surface having a protruding means for preventing movement of the kickstand across the flat planar support surface, the kickstand support structured to fit within the second elongated opening on the other side of the casing, the kickstand support further comprising a kickstand support outer edge capable of covering the second opening of the casing, the kickstand support outer edge having a means for grasping the kickstand support to insert the kickstand support into and remove the kickstand support from the casing.

2. The device of claim 1 wherein the mating spaced openings of the casing are positioned adjacent to a bottom edge of the casing and further comprising a protruding track ridge between the two planar casing surfaces aligned with the tops of the mating spaced openings, the protruding track ridge defining a bottom edge of an interior of the casing to maintain any contents of the casing above the mating spaced openings.

3. The device of claim 2 wherein a portion of the protruding track ridge adjacent to the second elongated opening comprises a lower beveled insertion track along the top of the protruding track ridge and an interior portion of the top interconnecting edge of the casing adjacent to the second elongated opening comprises an upper beveled insertion track, and the kickstand support further comprises a top beveled edge mating with the upper beveled insertion track of the casing and a bottom beveled edge mating with the lower beveled insertion track of the casing so that the kickstand support slides into the second elongated opening of the casing on the beveled insertion tracks with a tight friction fit.

4. The device of claim 1 wherein the means for securing the “wallet” in the casing comprises at least one protrusion from one capable of snap fitting into engagement into an aligned indent in the other.

5. The device of claim 4 wherein the casing further comprises a rim around at least one of the spaced openings located on the side of the first elongated opening and the casing comprises an indent adjacent to an inside edge of the rim and the “wallet” further comprises a mating protrusion capable of engaging the indent with a snap fit.

6. The device of claim 1 wherein the “wallet” is formed of molded plastic and the mating edge comprises a living hinge.

7. The device of claim 1 wherein the protruding means for preventing movement of the kickstand across the flat planar support surface comprises a pair of ridges protruding from the flat planar surface with one of the pair positioned at an angle relative to the other to form a stop for the kickstand to prevent the kickstand from horizontal movement over the flat planar support surface of the kickstand support.

8. The device of claim 1 wherein all of the components are formed of molded plastic and further comprising a series of indents in one of the two planar casing surfaces and a series of mating protrusions in the other of the two planar casing surfaces, the series of indents being capable of receiving the series of mating protrusions to secure the two planar casing surfaces together.
